(19) United States
(12) Patent Application Publication
(10) Pub. No.: US 2015/0149225 A1
(43) Pub. Date: May 28, 2015

(54) Automatically Determining Targeted Investigations on Service Delivery Incidents

(71) Applicant: INTERNATIONAL BUSINESS MACHINES CORPORATION, ARMONK, NY (US)

(72) Inventors: Hari S. Gupta, Jaipur (IN); Srikanth G. Tamilselvam, Bangalore (IN); Bikram Sengupta, Bangalore (IN)

(73) Assignee: INTERNATIONAL BUSINESS MACHINES CORPORATION, ARMONK, NY (US)

(21) Appl. No.: 14/090,460

(22) Filed: Nov. 26, 2013

(51) Int. Cl. G06Q 10/06

(52) U.S. Cl. CPC G06Q 10/0631
USPC 705/7.12

(57) ABSTRACT

Methods, systems, and articles of manufacture for automatically determining targeted investigations on service delivery incidents are provided herein. A method includes creating an incident profile for a given set of incidents, wherein the incident profile comprises one or more details associated with the given set of incidents; matching the created incident profile with one or more existing class profiles associated with one or more incident investigation classes based on a comparison of the one or more details associated with the given set of incidents to the one or more existing class profiles; identifying one incident investigation within the one or more existing class profiles matching the created incident profile that most closely matches the created incident profile; and generating a recommendation to create an investigation for the given set of incidents based on the one incident investigation within the one or more existing class profiles.

### FIELD OF THE INVENTION

Embodiments of the invention generally relate to information technology (IT), and, more particularly, to IT service delivery.

### BACKGROUND

Triggering investigations for exceptional patterns in logged incident data is a common practice in IT service delivery contexts. In existing approaches, investigations are commonly triggered by manually observing graphs and/or statistics collected from incident data, subject to the discretion of human analysts. However, such approaches are experience-oriented and time-consuming processes. The volume of underlying incident data and the existence of non-specific and/or evolving patterns provide further challenges.

Missed opportunities for investigation through manual analysis can lead to increased incident volume, higher maintenance costs and service level agreement (SLA) penalties. Accordingly, a need exists for automated techniques for determining and recommending targeted investigations on incidents in IT service delivery.

### SUMMARY

In one aspect of the present invention, techniques for automatically determining targeted investigations on service delivery incidents are provided. An exemplary computer-implemented method can include steps of creating an incident profile for a given set of incidents, wherein the incident profile comprises one or more details associated with the given set of incidents; matching the created incident profile with one or more existing class profiles associated with one or more incident investigation classes based on a comparison of the one or more details associated with the given set of incidents to the one or more existing class profiles; identifying one incident investigation within the one or more existing class profiles matching the created incident profile that most closely matches the created incident profile; and generating a recommendation to create an investigation for the given set of incidents based on the one incident investigation within the one or more existing class profiles.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating techniques according to an embodiment of the invention;

FIG. 2 is a block diagram illustrating an example embodiment, according to an aspect of the invention;

FIG. 3 is a flow diagram illustrating techniques according to an embodiment of the invention; and

FIG. 4 is a system diagram of an exemplary computer system on which at least one embodiment of the invention can be implemented.

### DETAILED DESCRIPTION

As described herein, an aspect of the present invention includes automatically determining and recommending targeted investigations on incidents in IT service delivery. At least one embodiment of the invention includes automatically determining and/or suggesting investigations on new incidents based on non-invasively recording and preserving key characteristics of investigations that were carried out by human experts on historical tickets. Additionally, an example embodiment of the invention includes a combination of techniques related to information clustering, matching and summarization to efficiently learn from investigation objects involving structured and unstructured data, as well as time-series and other statistical data on performance.

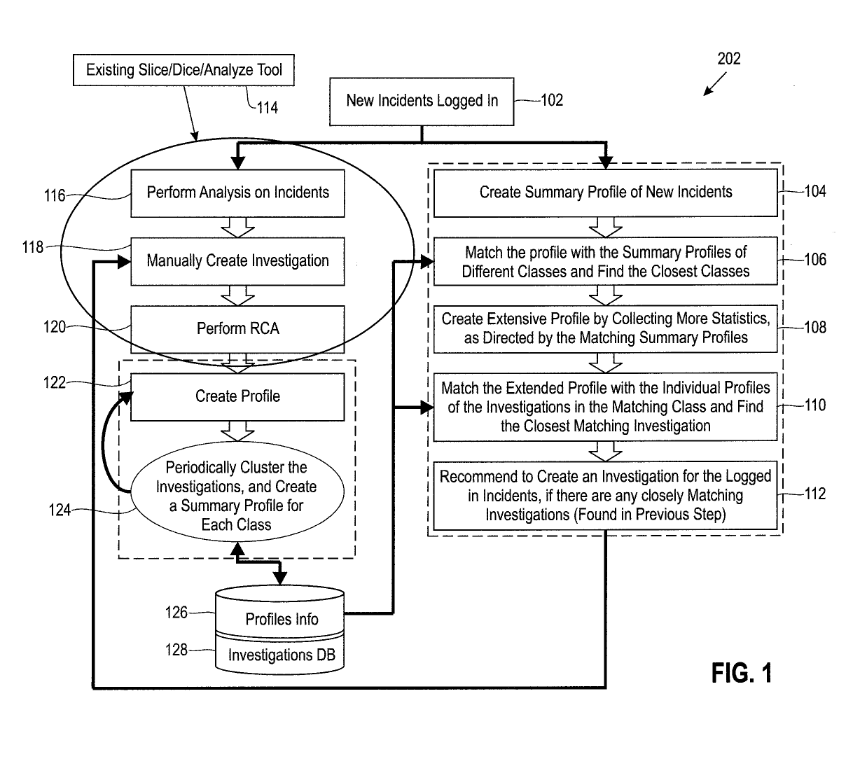

FIG. 1 is a flow diagram illustrating techniques according to an embodiment of the invention. By way of illustration, FIG. 1 depicts an existing tool (or tool set) 114 (such as, for example, a human expert) which is capable of slicing and/or filtering volumes of incidents (such as incidents 102) to create clusters of tickets of interest. As noted via step 116, the tool 114 can trigger analysis on incidents such as, for example, the computation of performance characteristics on the volume of incidents, turn-around time, SLA misses, etc. Additionally, such analysis can be represented by appropriate graphical mechanisms (time-series plot, histogram, etc.).

The tool 114 can also determine whether the performance results suggest a need for investigation; if so, such investigations are manually created and managed (as noted via step 118). Root cause analysis (RCA) can be performed via step 120, a profile for each investigation can be created via step 122, and investigation-related information is recorded (investigation description, root cause, etc.) in relevant databases such as profile database 126 and investigations database 128. An investigation profile can include, by way of example, a description of the investigation, an identification of the root cause, a category of problem (time, volume, breach, etc.), and graphs for the selection paths corresponding to the containing cluster. As used herein, a path refers to a sequence of selection and projection of data resulting in a filtered set of incidents with the projected attributes.

Additionally, as noted via step 124, at least one embodiment of the invention includes periodically clustering investigations and create a summary profile for each such cluster and/or class of investigations. A cluster summary profile can include, by way of example, a set of selection paths, as well as a set of graphs, wherein each graph corresponds to a selection path. A graph represents the problematic pattern which led to the triggering of an investigation in the past. Accordingly, the intermediate output generated via step 124 can include a profile cluster which contains all investigation details pertaining to this cluster along with an identified path and time period distribution (used for plotting a process behavior analysis (PBA), for example) that represents this cluster. This output can be applied on the incoming ticket dataset 102, as detailed additionally herein.

At least one embodiment of the invention includes recording actions on incidents (such as for example, from database 126 and database 128) to construct an investigation selection path. The path, along with the associated performance characteristics, represent a pattern of exceptional behavior as determined by a human expert. Such techniques include extracting patterns from past investigations and applying frequently occurring path selection operators on new incidents (also referred to herein as tickets), such as incidents 102 in FIG. 1, to determine the possibility of exceptional behavior based on closeness of generated results.

As depicted in FIG. 1, step 104 includes creating a summary profile of new incidents 102. A summary profile for newly logged-in incidents can include, for example, graphs and selection paths corresponding to all of the cluster's profiles. Additionally, step 106 includes matching the created summary profile with one or more summary profiles of different clusters/classes stored in database 126 and determining the closest class/cluster matches therein. Step 108 includes creating a more extensive profile (of the summary profile created in step 104) by collecting additional statistics (such as skewness of volume over time, periodic trend, etc.), based upon guidance and/or direction imparted by the matching carried out in step 106. Subsequently, in step 110, the extended profile can be matched with one or more individual profiles of investigations in the one or more matched classes/clusters (as identified in step 106) to determine the closest matching individual investigation. Further, step 112 includes generating a recommendation to create an investigation for incidents 102 based on the matched investigations identified in step 110.

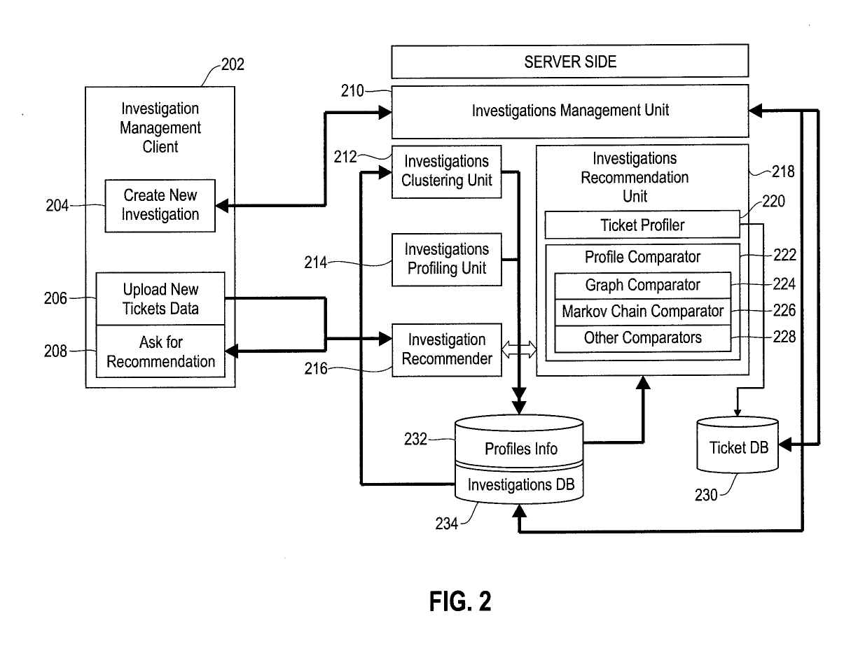

In connection with techniques such as those detailed in FIG. 1, FIG. 2 is a block diagram illustrating an example embodiment, according to an aspect of the invention. As depicted in FIG. 2, an investigation management client component 202 can carry out actions such as creating a new investigation in step 204, uploading new ticket or incident data in step 206 and querying for a recommendation in step 208. As also depicted in FIG. 2, the investigation management client 202 can interact with a server side, which can include an investigations management unit 210, an investigations clustering unit 212, an investigations profiling unit 214, an investigation recommender component 216 and an investigations recommendation unit 218. The server side can also include a profile information database 232, an investigations database 234 and a ticket database 230.

As illustrated in FIG. 2, the investigations recommendation unit 218 includes a tickets profile component 220 and a profile comparator component 222. The profile comparator component 222 further includes a graph comparator component 224, a Markov chain comparator component 226 and other comparators component 228.

At least one embodiment of the invention includes creating profiles from past investigation data. As depicted in FIG. 2, the investigations clustering unit 212 and the investigations profiling unit 214 interact with the profile information database 232 and the investigations database 234 to carry out this task. Specifically, existing investigations can be clustered, for example, based on RCA description and/or other fields (investigation description, etc.). For each cluster, the top X (for example, 10) path selections which have been used in the noted investigations are determined. In at least one embodiment of the invention, every investigation is associated with some path selections. Then, for each cluster, the most frequent X paths (for example, the top 10 or 15) across investigations belonging to the cluster can be selected. For each investigation in the cluster, the X path selections are applied thereto and corresponding graphs are generated.

Additionally, for each path selection chosen from X, at least one embodiment of the invention includes computing the prominence of the corresponding graph (that is, the maximum number of investigations in which the graph exhibits a similar pattern). In at least one embodiment of the invention, prominence can be computed by various methods, such as, for example, determining the frequency of a graph across investigation classes. The most prominent graphs (SET-G) for the cluster are identified based on the computed prominence.

For each graph in SET-G, at least one embodiment of the invention includes computing a summary graph of all matching investigations for the given graph. This can be carried out, for example, by normalizing all matching graphs (that is, the graphs from the investigations which are matching for the given graph class) along the x- and y-axis, in terms of their areas to 1. Such a technique additionally includes generating equi-distant points on the x-axis in the normalized graphs, taking a point-wise average of the values in the normalized graphs, and drawing a summary graph from these mean values. The summary graphs and selection paths can be collected and identified as the profile of the cluster.

As detailed herein, at least one embodiment of the invention also includes recommending investigations for newly-logged-in incidents. As depicted in FIG. 2, the investigations recommendation unit 218 interacts with the investigation recommender component 216 as well as the ticket database 230 and the profile information database 232. Accordingly, such embodiments of the invention include generating paths for the new incidents corresponding to each cluster's profile in the past investigations data, such as described above.

For each cluster C₁, at least one embodiment of the invention includes matching the graphs of the new incidents corresponding to the cluster C₁ (generated as detailed above) with the summary graphs in the profile of cluster C₁. A matching of paths can be carried out using exact or approximate matching of selection paths. In accordance with at least one embodiment of the invention, various types of graph-matching algorithms (for example, the difference between areas under the curves) can be used to carry out the matching of selection paths. Additionally, for path-matching, Markov chains-based comparisons can be implemented.

A cluster score S₁ is computed and assigned to the cluster based on the matching. For example, a cluster score can include the average of matching probabilities of all summary graphs (or the top Z graphs). Accordingly, one or more embodiments of the invention further include determining the most closely matching clusters based on the computed cluster scores and recommending the top investigation types from the matching clusters.

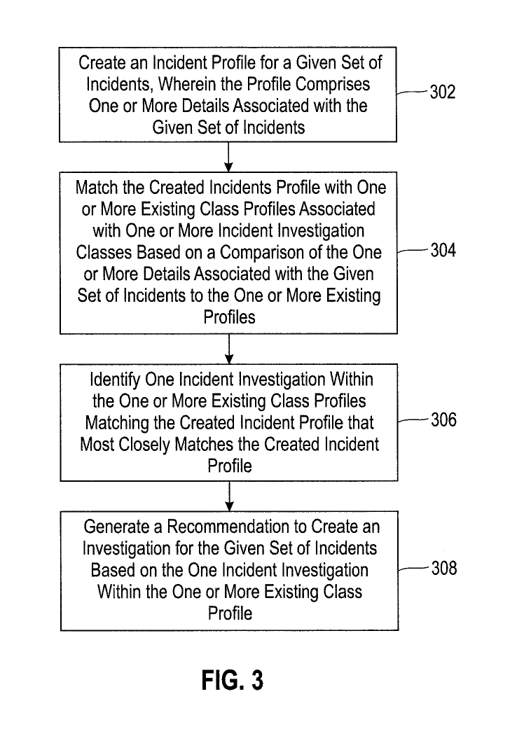

FIG. 3 is a flow diagram illustrating techniques according to an embodiment of the present invention. Step 302 includes creating an incident profile for a given set of incidents, wherein the incident profile comprises one or more details associated with the given set of incidents. The techniques depicted in FIG. 3 can also include supplementing the created incident profile with one or more statistics (for example, based upon said comparison of the one or more details associated with the given set of incidents to one or more existing class profiles).

Step 304 includes matching the created incident profile with one or more existing class profiles associated with one or more incident investigation classes based on a comparison of the one or more details associated with the given set of incidents to the one or more existing class profiles. The existing class profiles can include a set of graphs, wherein each graph corresponds to a pattern which led to a triggering of a past incident investigation. Also, the existing class profiles comprise structured and/or unstructured data, time-series data, and/or statistical data pertaining to performance.

Step 306 includes identifying one incident investigation within the one or more existing class profiles matching the created incident profile that most closely matches the created incident profile. Step 308 includes generating a recommendation to create an investigation for the given set of incidents based on the one incident investigation within the one or more existing class profiles.

At least one embodiment of the invention can additionally include clustering multiple past incident investigations into one or more investigation classes based on investigation-related information. Such an embodiment additionally includes creating a profile for each of the one or more investigation classes, wherein the profile comprises (i) one or more investigation details associated with the given investigation class, (ii) at least one traversed path associated with the given investigation class, and (iii) a time period distribution associated with the given investigation class.

The profile for each of the one or more investigation classes can include performance characteristics on volume of incidents, turn-around time, and/or service level agreement completion. Also, the profile for each of the one or more investigation classes can include a root cause analysis associated with each of the multiple past incident investigations.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

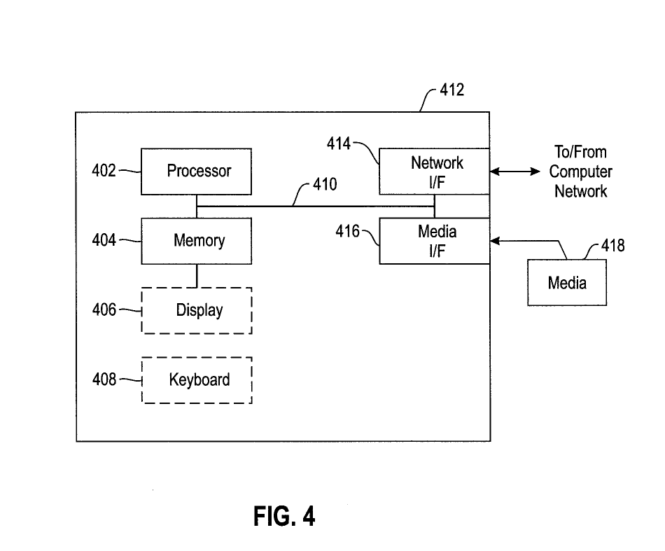

Additionally, an aspect of the present invention can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 402. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, recommending investigations from incident data automatically based on past investigation profiles.

The descriptions of the various embodiments of the present invention have been presented for purposes of illustration, but are not intended to be exhaustive or limited to to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
creating an incident profile for a given set of incidents, wherein the incident profile comprises one or more details associated with the given set of incidents;
matching the created incident profile with one or more existing class profiles associated with one or more incident investigation classes, based on a comparison of the one or more details to the one or more existing class profiles;
identifying one incident investigation within the one or more existing class profiles matching the created incident profile that most closely matches the created incident profile; and
generating a recommendation to create an investigation for the given set of incidents based on the one incident investigation within the one or more existing class profiles;
wherein at least one of said creating, said matching, said identifying, and said generating is carried out by a computing device.

2. The method of claim 1, comprising:
supplementing the created incident profile with one or more statistics.

3. The method of claim 2, wherein said supplementing comprises supplementing the created incident profile based upon said comparison.

4. The method of claim 1, wherein said one or more existing class profiles comprise a set of graphs, wherein each graph corresponds to a pattern which led to a triggering of a past incident investigation.

5. The method of claim 1, wherein said one or more existing class profiles comprise structured data.

6. The method of claim 1, wherein said one or more existing class profiles comprise time-series data.

7. The method of claim 1, wherein said one or more existing class profiles comprise unstructured data.

8. An article of manufacture comprising a computer readable storage medium having computer readable instructions tangibly embodied thereon which, when implemented, cause a computer to carry out a plurality of method steps comprising:
creating an incident profile for a given set of incidents, wherein the incident profile comprises one or more details associated with the given set of incidents;
matching the created incident profile with one or more existing class profiles associated with one or more incident investigation classes based on a comparison of the one or more details associated with the given set of incidents to the one or more existing class profiles;
identifying one incident investigation within the one or more existing class profiles matching the created incident profile that most closely matches the created incident profile; and
generating a recommendation to create an investigation for the given set of incidents based on the one incident investigation within the one or more existing class profiles.

9. The article of manufacture of claim 8, wherein the method steps comprise:
supplementing the created incident profile with one or more statistics.

10. The article of manufacture of claim 8, wherein said supplementing comprises supplementing the created incident profile based upon said comparison of the one or more details associated with the given set of incidents to the one or more existing class profiles.

11. The article of manufacture of claim 8, wherein said one or more existing class profiles comprise a set of graphs, wherein each graph corresponds to a pattern which led to a triggering of a past incident investigation.

12. The article of manufacture of claim 8, wherein said one or more existing class profiles comprise time-series data.

13. A system comprising:
a memory; and
at least one processor coupled to the memory and configured for:
creating an incident profile for a given set of incidents, wherein the incident profile comprises one or more details associated with the given set of incidents;
matching the created incident profile with one or more existing class profiles associated with one or more incident investigation classes based on a comparison of the one or more details associated with the given set of incidents to the one or more existing class profiles;
identifying one incident investigation within the one or more existing class profiles matching the created incident profile that most closely matches the created incident profile; and
generating a recommendation to create an investigation for the given set of incidents based on the one incident investigation within the one or more existing class profiles.

14. A method comprising:
clustering multiple past incident investigations into one or more investigation classes based on investigation-related information;
creating a profile for each of the one or more investigation classes, wherein the profile comprises (i) one or more investigation details associated with the given investigation class, (ii) at least one traversed path associated with the given investigation class, and (iii) a time period distribution associated with the given investigation class;
creating an incident profile for a given set of incidents, wherein the incident profile comprises one or more details associated with the given set of incidents;
matching the created incident profile with one of the investigation class profiles;
identifying one of the multiple past incident investigations within the investigation class profile matching the created incident profile that most closely matches the created incident profile; and
generating a recommendation to create an investigation for the given set of incidents based on the one incident investigation within the one or more existing class profiles;
wherein at least one of said clustering, said creating a profile, said creating an incident profile, said matching, said identifying and said generating is carried out by a computing device.

15. The method of claim 1, wherein said one or more existing class profiles comprise a set of graphs, wherein each graph corresponds to a pattern which led to a triggering of a past incident investigation.

16. The method of claim 1, wherein said one or more existing class profiles comprise structured and/or unstructured data.

17. The method of claim 1, wherein said one or more existing class profiles comprise time-series data.

18. The method of claim 1, wherein said one or more existing class profiles comprise statistical data pertaining to performance.

19. The method of claim 14, wherein said profile for each of the one or more investigation classes comprises performance characteristics on volume of incidents, turn-around time, and/or service level agreement completion.

20. The method of claim 14, wherein said profile for each of the one or more investigation classes comprises a root cause analysis associated with each of the multiple past incident investigations.
